(19) United States
(12) Patent Application Publication
(10) Pub. No.: US 2011/0108758 A1
(43) Pub. Date: May 12, 2011

(54) Method for Making Phase Change Aggregates From a Microencapsulated Phase Change Material Liquid Emulsion

(76) Inventor: Joseph A. Driscoll, Honey Creek, IA (US)

(21) Appl. No.: 12/356,144

(22) Filed: Jan. 20, 2009

(51) Int. Cl. C09D 5/18; C09K 5/00

(52) U.S. Cl. 252/79; 106/505; 106/18.11; 106/18.26

(57) ABSTRACT

The present invention provides a method of producing manufactured aggregates from a mPCM slurry, by combining a cementitious binder with the slurry in an agglomeration process. Also, other materials may be introduced (e.g., CaO). The agglomerated feed mix then goes through a curing and classification process to meet the size criteria of the end product. The invention also provides a method of manufacturing PCM aggregates that are substantially fire retardant by mixing the PCM particles with magnesium hydroxide or aluminum hydroxide. Water may be added to assure uniform distribution of particles with the hydroxide particles. Alternatively, the hydroxides may be obtained in situ by mixing magnesium oxide or aluminum oxide with water prior to mixing with the PCM particles.

### BACKGROUND OF THE INVENTION

1. Field of the Invention

The present invention relates generally to the field of cementitious aggregates, and more particularly to an aggregate with significant thermal storage capacity formed by the agglomeration of a micro encapsulated phase change material (mPCM) liquid emulsion slurry and a cementitious binder.

2. Description of Related Art

Phase change materials (PCM) are thermal storage materials that are capable of storing large amounts of thermal energy that can be useful in moderating daytime nighttime temperature fluctuations. At present a great deal of interest and markets exist for PCM. Well engineered lightweight structures utilizing PCMS typically reduce cycling of heating and cooling machinery and cause the buildings temperatures to more closely remain in the comfort zone for occupants. It is sometimes beneficial to incorporate PCM into cementitious building materials and other products, but all known methods of doing so require that dry, microencapsulated PCM (mPCM) powder be mixed directed into the concrete mix of the end product. Concretes used to make building materials and other end products typically contain aggregates that constitute a substantial part of the concrete mix. PCMs can be hydrated salts, plastic crystals, hydrated salts with glycols or hydrocarbon waxes. The present invention more generally relates to hydrocarbon waxes. Ciba Specialty Chemicals U.S. Pat. No. 6,716,526 B1 and BASF U.S. Pat. No. 6,200,681 B1 describes the manufacturing process for making micro encapsulated hydrocarbon wax phase change particles. The manufacturing process of mPCM produces an aqueous emulsion that contains both solids and liquids. The solids portion, typically 42 to 48 percent, are mPCM wax particles encased by an acrylic shell. The liquid portion contains from 58 to 52 % water with wax and acrylics residues not bound up to the solids in the production process. Heretofore, it has been necessary to remove the mPCM solids from the acrylics dispersion in the slurry by a costly drying process to effectively incorporate mPCM into any other product.

An obstacle to the acceptance of PCM in building materials has been that PCM is inherently flammable. The PCM itself is a hydrocarbon, typically a paraffin, that burns very easily. The PCM capsule material, whether a polymer acrylic, melamine/formaldehyde, or some other material, is also inherently flammable.

There are a number of processes in the prior art for making mPCM and for the use of mPCM in concrete or other cementitious end products.

U.S. Pat. No. 4,747,240, issued May 31, 1988 for Encapsulated PCM Aggregate-Voisinet et al., describes a process in which PCM as an admix is incorporated directly into a variety of cementitious interior building materials. In that patent, mPCM or “form stabilized”, nonencapsulated PCM, is incorporated directly as an aggregate into a cementitious composition. This invention does not contemplate an aggregate of various sizes, but describes the PCM particles as aggregate.

Similarly, U.S. Pat. No. 7,166,355, issued Jan. 23, 2007 for Use of Microcapsules in Gypsum Plaster board—Jahns et al., discusses a process wherein mPCM is incorporated directly into cementitious building material, i.e., wallboard core and plasterboard. In this patent special steps must be taken to insure the bonding of all components because of the poor bonding nature of the mPCM particles.

### BRIEF SUMMARY OF THE INVENTION

Briefly stated, the present invention provides a method of manufacturing engineered phase change aggregates directly from typical aqueous mPCM emulsions by combining a cementitious binder with the slurry in an agglomeration process that bypasses or eliminates the costly spray drying process. The invention also provides types of fast setting cements and dessicants that bind up a high percentage of the water in the aqueous mPCM fluid and set fast enough to allow a continuous mPCM aggregate production process. Other materials may be introduced (e.g., CaO). The agglomerated feed mix then goes through a curing and classification process to meet the size criteria of the end product. The invention also provides a method of manufacturing PCM aggregates that are substantially fire retardant by mixing the PCM particles with magnesium hydroxide or aluminum hydroxide. Water may be added to assure uniform distribution of particles with the hydroxide particles. Alternatively, the hydroxides may be obtained in situ by mixing magnesium oxide or aluminum oxide with water prior to mixing with the PCM particles.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with drawings, wherein:

FIG. 1 is a flow diagram illustrating the method of the present invention.

### DETAILED DESCRIPTION OF THE INVENTION

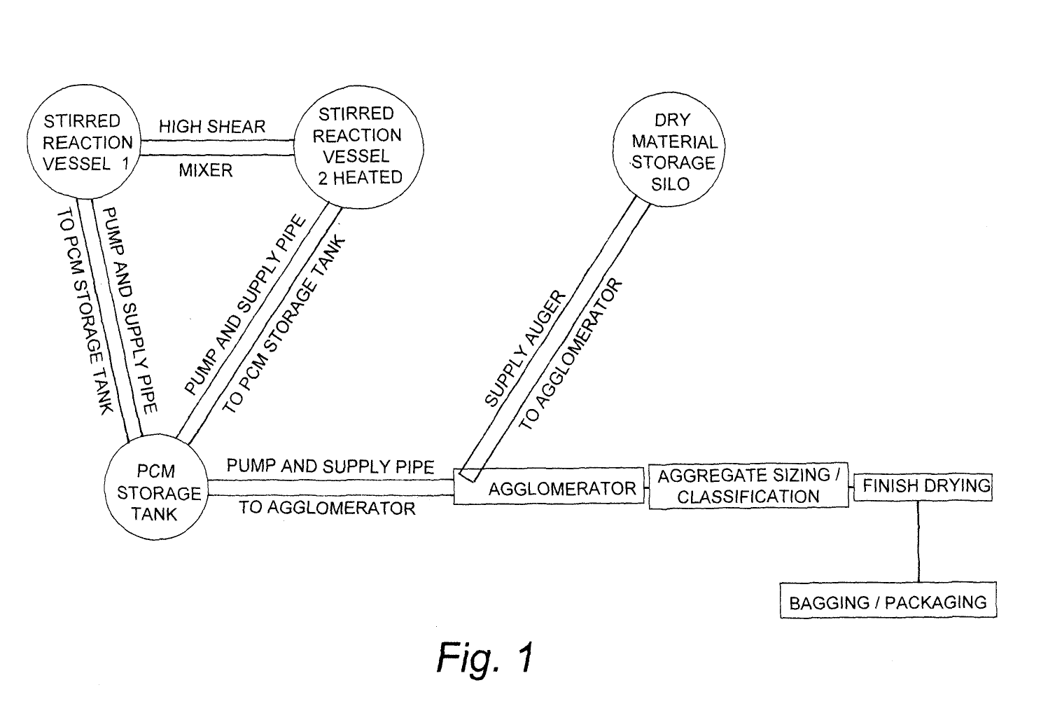

As can be seen by reference to the drawings, and the following Examples, the method that forms the basis of the present invention is generally illustrated in the flow diagram of FIG. 1.

Definitions:

Agglomeration: a size enlargement process by which smaller particles are made into larger particles by briquetting, pelletizing, extruding, agglomerating, or other size enlargement methods.

Aggregates: materials of various shapes, sizes and compositions capable of being bound together with other such materials by cement.

Manufactured aggregates: material produced by mixing, agglomeration and curing with properties that meet with specifications of the concrete in which it will be incorporated.

Mixing: a process step to blend feed stocks to form a feed mix prior to agglomeration. Ideally, mixing causes particles of the feed stocks to come into close proximity to one another and particles of the feed stocks become uniformly distributed throughout the feed mix.

Feed Stocks: materials that are blended together by mixing. In this invention, the term includes (a) PCM particles; (b) any other materials that are not PCM particles, but were part of the PCM manufacturing process (e.g., the fluid portion of a slurry or emulsion, the acrylic or melamine/formaldehyde comprising the capsule of mPCM, and other matter left over from production processes contained in the slurry or emulsion, etc.), and (c) the cement and/or desiccant materials, and combinations thereof, as well as any other material added to solidify and improve fire resistant qualities of the feed mix and the aggregate that will be made from the feed mix.

Feed Mix: mixture of PCM and other feed stocks, (and water where required,) prior to agglomerating.

Cement: any combination of inorganic materials that can act as a bonding agent to bind other materials together into a hardened mass (e.g. Portland Cement, plaster of Paris, silicate cement, magnesium phosphate cement, magnesium oxychloride cement, magnesium oxysulfate cement, etc.).

Cementitious: a term descriptive of anything made up of materials bound together in a hardened mass of cement.

Concrete: a mixture of aggregates and cement.

End Product: whatever is to be manufactured. In this case, where building materials are the end product, the term includes, but is not limited to, bricks, blocks, boards, wall tiles, paving, ceiling materials (ceiling tiles, etc.), flooring (floor tiles, underlayment, etc.), concrete articles, mortars, renders, plasters, cements, room furnishings, heating and cooling ductwork etc.

Fire Resistant/Fire Retardant: “fire resistance” and “fire retardant” are sometimes used interchangeably but imply a subtle difference in fire properties. In this invention, we define fire or flame retardant to mean a material that resists burning or burns slowly and fire resistant to mean a material that resists burning to the extent it can act as a fire barrier. Varying degrees of fire resistance are defined in safety codes and capable of objective measurement. The aggregate of this invention can be designed and manufactured to provide varying degrees of fire resistance.

PCM: phase change material(s) are heat storage materials that act as thermal mass. The principal behind PCM is that the materials' latent heat of fusion is substantially greater than its sensible heat storing capacity (i.e., the amount of heat that the material absorbs when melting, or releases when freezing, is much greater than the amount of heat that the material absorbs or releases by cooling or heating when undergoing the same amount of temperature change in ranges below and above the phase change temperature.) As used herein, PCM refers to the wax or other hydrocarbon that comprises such material in a particulate form, by which is meant both encapsulated (in a powder, slurry, or cake), or non-encapsulated (in an emulsion.)

Some suitable paraffinic hydrocarbon phase change materials are shown below in the following table which indicates the number of carbon atoms contained in such materials, which is directly related to the melting point of such materials.

| | | MELTING |
|---|---|---|
| COMPOUND | NUMBER OF | POINT DEGREES |
| NAME | CARBON ATOMS | CENTIGRADE |
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

In addition to the paraffinic hydrocarbons and hydrated salts described above, plastic crystals such as DMP and HMP and the like may be used as temperature stabilizing materials. When plastic crystals absorb thermal energy, the molecular structure is temporarily modified without changing the phase of the material. Plastic crystals may be employed alone or in combination with other temperature stabilizing materials in any of the configurations described herein.

mPCM: microencapsulated phase change material. PCM is encapsulated so it will remain in place while in its liquid phase. Microencapsulation typically takes place in a process wherein PCM, in liquid phase, is contained within a temperature controlled fluid media that also contains a material that will act as the “shell” or “capsule” for the PCM, as well as other materials required for the production process. A physical and/or chemical action takes place within the fluid media which causes microscopic particles of liquid PCM to be formed within a thin layer of shell material. The shell material, which has a higher phase change temperature, hardens around the tiny particles of liquid PCM, and as the media cools further, the encased PCM particles also become solid. After the process, the particles are generally referred to as mPCM. These are contained in a slurry (i.e., the fluids used in the manufacturing process and the mPCM particles) that generally contains from 80% to 90% mPCM solids.

PCM Emulsion: where PCM is not encapsulated it is in the form of an emulsion comprised of the PCM, either in liquid or solid phase, stabilized in a fluid media. The term embraces emulsion systems wherein particles of PCM are liquid (molten) or solid (crystallized.) Furthermore, the PCM particle size in an emulsion is generally limited to a fairly narrow range, typically between 0.05 μm and 50 μm, often between 0.1 μm and 20 μm and more often between 0.5 μm and 10 μm (expressed as volume mean diameter as determined, for example, by a Sympatec particle size analyzer.) Therefore this definition includes emulsions described as microemulsions and nanoemulsions.

Residence time: The amount of time a particle or specific volume of liquid dwells within a continuous mixing or agglomerating machine. The time lapse between specific particle or liquid inflow and outflow. Residence time in this invention is controlled by the rate of inflow of dry feed and liquid feed.

### EXAMPLE 1

A phase change aggregate with an enthalpy of 31 j/g and a mean particle size of ⅛ inch was produced in a rotating drum agglomerator in a continuous production method. An acid/base dry feed cement comprised of 11% magnesium oxide,27% monopotassium phosphate, 5% wollastiite, 44% class c fly ash, 11% magnesia aluminum silicate was introduced into the rotating agglomerator at a rate of 6.52 pounds per minute. A like amount of Ciba Chemicals DPBT 0031 mPCM liquid emulsion was pumped to a fine spray nozzle inside the drum agglomerator. With a residence time of 3.1 minutes inside the rotating drum agglomerator a phase change aggregate with mean average diameter if ⅛ inch and an aggregate outflow rate of 0.3 cubic feet per minute was produced in a continuous test production method.

### EXAMPLE 2

A binder was prepared using dead burned Magnesium Oxide (HR98 from Martin Marietta), finely ground Monopotassium phosphate 300 mesh and class C flyash in a ratio of 1:3:7. 100 grams of MgO, 300 grams of MKP, and 700 grams of flyash were combined as dry ingredients. This mixture was added to 2400 gram of mPCM CIBA CHEMICALS DPNT 0031. When mixed the sample began to gel and harden within 30 seconds. After 1 hour the sample was broken into particles of ½ inch or less with a high speed shear mixer. . The dry particles, now usable as an aggregate in concrete mixes, were tested to contain 35% PCM solids with enthalpy of 47 J/G.

### EXAMPLE 3

100 grams of mPCM CIBA CHEMICALS DPNT 0031 slurry was mixed with 100 grams of magnesium alumina silicate powder Acti-Gel 208. Within 15 seconds, all of the fluid of the slurry was absorbed, leaving a sand like substance. Flame from a propane torch was applied directly to the sand like substance, both immediately after mixing, and after it had been allowed to dry for 24 hours, and in both instances, the substance could not be ignited, although it contained thirty percent mPCM with a measured enthalpy of 34 J/G.

### EXAMPLE 4

An aggregate was prepared by mixing 100 grams diatomaceous earth, 100 grams hydrous sodium silicate (type G from PQ Corp.), 100 grams of dead burned magnesium oxide (HR98 from Martin Marietta) with 1,000 grams of mPCM CIBA CHEMICALS DPNT0031 slurry. This mixture was allowed to cure and dry, resulting in a hardened, solid mass. The mass was then sized by placing in a blender resulting in an aggregate from fine sand to ¼ inch gravel in size. The entire dried sample, weighing 1040 grams, was then mixed together with a binder consisting of 400 grams of light burned magnesium oxide (Oxymag from Premier Chemicals), 300 grams of liquid magnesium chloride (35 baume from Cargill), and filler comprised of 467 grams of wet sawdust. During mixing, 180 grams of water was added, as well as 34 grams of a dispersant. The resulting mix was placed in a mold to produce a 26 cm×31 cm size wallboard, 15 mm thick. The average enthalpy was 23.5 J/G,density was 1.35 g/cm3 and board area enthalpy was 540 KJ/m3.

### EXAMPLE 5

In one example of this invention, CIBA mPCM slurry is added to a like weight of a mix of the following dry materials: fly ash (from 30% to 70% by weight of the dry mix), magnesium oxide (from 10% to 50%) monopotassium phosphate (from 20% 5o 60%), aluminum silicates (from 5% to 25%). The slurry and the dry mix is thoroughly blended together and allowed to harden and dry. When semi-solid, the mix can be broken up by any conventional means, such as grinding. When fully cured and dried, the material size can be further reduced by conventional methods in order to achieve a desired particle size. If the slurry contained 45% mPCM solids, the resulting mixture would contain 22.5% mPCM solids on a wet basis. When fully cured the amount of mPCM solids in the resulting dry aggregate will be about 6 percent higher.

### EXAMPLE 6

In another example, the dry mix would be comprised of lightly calcined magnesium oxide (10% to 40%), dolomite powder (10% to 40%), magnesium chloride hexahydrate (10% to 40%), antimony pentoxide (5% to 20%) and diatomaceous earth (20% to 50%). To this dry mixture, mPCM slurry is added in a ratio of one part of dry mix to two parts slurry. Again, these ingredients are thoroughly mixed and allowed to harden and dry. If the slurry contained 45% of mPCM solids, the resulting mixture would contain about 37% solids on a wet basis. Again, the percentage of mPCM solids in the dry, fully cured aggregate will be higher.

### EXAMPLE 7

A fire resistant board with an estimated B- fire rating was made as follows. Dry ingredients 435 grams magnesium oxide, Martin Marrietta HR 98,425 grams 300 mesh monopotasium phosphate, 250 grams wollastinite, and 250 grams class C fly ash comprise a magnesium phosphate cementitious material. This is mixed with wet ingredients: 15 grams super plastisizer,500 grams CIBA CHEMICALS DPNT-0176 and 820 grams of water. The dry ingredients were mixed thoroughly with the wet and placed in a 26 cm×31 cm×1.27 cm mold. A layer of 2.5 oz. fiberglass was placed on both sides. The board hardened and was de-molded in 8 hours. A Perkin Elmer Pyrus DSC1 was used to test board enthalpy. Board enthalpy was 29.7 J/G, density was 1.15 g/cm3 and board are enthalpy was 427 KJ/m2. A propane torch was positioned 7 cm from the board face. The torch flame was directed at the center of the board and held in place for 10 seconds, flame extinguished when the torch was removed. The torch was applied a second time for 30 seconds when the torch was removed the flame again extinguished.

### EXAMPLE 8

A phase change aggregate as described above with an average diameter of ¼ inch and with all fine particles removed was placed in a rectangular enclosure measuring 3 inches by 3 inches by 12 inches high with a volume of 108 cubic inches. Tests revealed 32 percent void space between phase change aggregate particles for air or fluid to flow through. A total of 1.84 pounds of phase change aggregate with an enthalpy of 34 j/g was placed in the enclosure. A volume 2 cfm 50 degree farenheit air was introduced at the bottom for 8 hours to simulate nighttime air conditions. Tests revealed significant potential for use of the phase change aggregate as a heat exchange media to capture cool night time air for day time cooling.

Commercially available dry mPCM when incorporated in cementitious building materials has many drawbacks. The microscopic particle size increases water demand beyond typical water cement ratios and special precautions must be taken to avoid inhaling the particles. U.S. Pat. No. 6,099,894 mentions these precautions. Acrylics and other chemical residues retard set times. Scanning Electron Micrographs show mPCM interferes with crystaline and amorphous structure formation in Portland cement, gypsum plasters and acid/base cements. The acrylic shell material has poor bonding qualities when incorporated in typical cements used in building products. Patent No. EP0344013 discloses that the PCM particles reduce concrete strength and interfere with crosslinking. Dry mPCM can be added, for example, directly into a cement mix or to other ingredients in a process for manufacturing other cementitious materials. U.S. Pat. No. 5,804,297 for example, discloses a method for incorporating dry mPCM into a coating which is said to provide thermal insulation and latent heat storage characteristics to the underlying material. Similarly, U.S. Pat. No. 7,166,355 discloses a method for incorporating dry mPCM into a wet plaster mix used in making wallboard. In each of these cases, dry mPCM is directly incorporated into the end product, with no effective fire resistance being imparted to the PCM material. In each case, the end product would be a greater fire hazard with the PCM, which is highly flammable, than without it.

Neither of these methods addresses the health hazards associated with the handling of dry mPCM. Neither deals with the flammability characteristics of PCM, nor is the use of mPCM in the form of slurry or cake, or is non-microencapsulated form even suggested.

By incorporating PCM into an aggregate, fire resistant qualities may be introduced by selection of the feedstock materials that are mixed with the PCM in the process of preparing the PCM aggregate and prior to agglomeration, curing and classification.

The aggregate may optionally include fire resistant materials. By using the mPCM to form a flame resistant aggregate, the present invention substantially mitigates the risks associated with flammability as well as the health hazards associated with the breathing and handling of the dry mPCM.

Depending on which cement system (hydraulic, silicate, or acid/base) is used, the mPCM particles will be contained within matrices of the three dimensional amorphous agglomeration formed by the cement and other materials comprising the hardened mix. The cross linking is not that of the mPCM particles, rather, it is the cement hardening into a three dimensional agglomeration. The aggregate particles can be made to be quite small. But even then will be far larger than the mPCM particles contained within it. The cement in the aggregate will further protect the PCM contained within the acrylic capsule. It will also present an ideal and easily handled material that will form a strong bond with any cementitious end product.

The present invention provides a cementitious aggregate using specially selected materials that will bind with the fluid media of the slurry or cake and encapsulate the mPCM solids within the cementitious aggregate formed thereby. In the case of mPCM powder, the cement is first made and then the powder is added. Nothing in the powder is used to make cement and the aggregate can be more heavily loaded with mPCM solids. The cement materials are selected based on what qualities are desired in the aggregate being made. For example, given the aggregate is to be incorporated into other cementitious products fire resistance may come from the aggregate or from the cementitious end products. The aggregate mix design is optimized to achieve the desired result when used in conjunction with these other cement products.

The aggregate is an agglomeration that can be made in any size, from fine sand to coarse gravel depending on the needs of the final product. ASTM C 125-07 fineness modulus principles are used to size phase change aggregate screen sizes to minimize cement binder and maximize phase change aggregate to achieve maximum enthalpy in the final product Many substances either by themselves or in combination, are capable of absorbing or becoming hydrated by the fluids of a mPCM slurry.

The process of combining or blending the slurry with such substances results in the production of an array of solid materials that can be made into aggregates for use in a variety of cementitious applications. These substances include, for example, powders with pozzolonic qualities, diatomaceous earth, anhydrous salts, fly ash, hydrous silicates, bentonite, super kayolins, Portland Cement, magnesia cements, metal oxide cements, phosphate cements, silicates, and a variety of other materials. Increased fire resistance is realized by the selection of these substances and by the addition of materials such as aluminum silicates, antimony trioxide, or antimony pentoxide or other recognized fire retarding materials.

In the mixing process the mPCM solids contained in the slurry are further incorporated within the aggregate. The result of the process is that aggregates made with mPCM slurry will be inert for purposes of mixing with other materials, but will be far easier and safer to handle and will have fire resistant qualities that are lacking in most dry mPCM.

Through selection of the amount and type of substances used in these processes, the mPCM aggregate can be tailored for qualities such as hardness, ability to bond with other materials, fire resistance, and amount of mPCM contained in it.

Further, the aggregate can be processed so that size and particle distribution of the aggregate may be optimized for a particular application or for more generally applicability.

U.S. Pat. No. 4,747,240 speaks to the utility of using encapsulated PCM in an aggregate in the manufacture of interior building materials. The mPCM employed in that invention was quite obviously mPCM in its dry form. The difficulties encountered when using mPCM in slurry form were not addressed, and no disclosure was made therein relating to manufacture and use of mPCM aggregate from slurry or cake. Likewise, no disclosure was made for making or using an aggregate of such composition that has fire resistant qualities, and of a size that avoids the need for hazard precautions.

Therefore, it is also an object of this invention to incorporate dry mPCM with water and a combination of the substances described above, in connection with PCM slurry, to make an aggregate with fire resistant qualities, and without hazards associated with the handling of the material.

It is an object of the present invention to combine mPCM in the form of slurry or cake with other materials that can be hydrated or that can absorb the water and other fluids contained therein. A partial listing of these materials is shown above. This will result in significant savings to mPCM manufacturers who would otherwise be compelled to remove the fluids from the slurry or cake by spray drying or by other costly means. It would also result in further encapsulation of the mPCM solids within the materials of the aggregate. In the process, the slurry or cake would become an integral part of a dry, sold aggregate with fire resistant qualities that may safely be handled without special hazard precautions or training required of the user. The resulting aggregate could be incorporated directly into a wide variety of cementitious materials and products made from such materials.

It is a further object of this invention to tailor the dry solids resulting from the above described processes in terms of size, particle distribution, compatibility with other materials, fire resistance, percentage of mPCM solids contained therein, suitability for any particular kind of cement system that may be employed therewith (e.g., Portland based, MagPhosphate based, MagOxychloride based,) or to any particular application wherein phase change qualities are imparted to a cementitious product by use of the aggregate.

The gist of the invention is that PCM can be incorporated within an aggregate which is then easily handled and which can then be incorporated into many cementitious final products without any radical modification to existing production procedures.

The aggregates produced by this invention can easily incorporate PCM into a wide range of building materials. It is therefore also an object of this invention that building materials, such as wall board, plaster, render, tiles, ceiling panels, floors, and floor underlayment, and any other building materials manufactured by any cementitious process be capable of adding phase change qualities by simply including the aggregate with the other feed stocks in the production processes used to produce those products.

In the present invention, the drying process for separating the mPCM for the encapsulation slurry is replaced with an agglomeration process wherein the slurry itself is used to make an aggregate with improved fire resistant qualities that can then be directly incorporated, as an aggregate, into the concrete mix of a wide variety of cementitious end products.

The present invention provides for the incorporation of PCM particles, both encapsulated and non encapsulated, in the form of dry powder, wet or damp cake, or contained within an emulsion, into an aggregate in order to impart improved fire resistant qualities to the PCM.

The use of aggregate as the means by which PCM is incorporated into cementitious end products has many advantages. As note, the cost of drying the mPCM slurry can be saved. Fire resistant qualities can be imparted to the PCM particles. Particles of PCM aggregate are easier and safer to handle than PCM powder. PCM aggregate can be custom manufactured so that it may be incorporated into building materials with little or no alteration required of the manufacturing processes of those building materials.

The present invention also relates to the manufacture of PCM aggregates through a process of mixing the PCM particles with other materials, agglomerating the resulting mixture into larger, agglomerated particles, curing the agglomerated particles, and classifying them for incorporation into the concrete mix of cementitious end products.

The prior art does not teach a process that provides the economic benefits and convenience provided by this invention which includes an innovative step where PCM particles, and in particular, the mPCM slurry, are made part of a manufactured aggregate according to specifications required by the end product, including those pertaining to fire resistance.

Unlike the present invention, U.S. Pat. No. 4,747,240 does not contemplate the manufacture of an aggregate from PCM, the use of mPCM liquid emulsion in a system that bypasses the spray drying process to make an aggregate, nor does it seek to mitigate the high degree of flammability that is characteristic of PCM.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A method of agglomerating a phase change aggregate for use in a cementitious product the method comprising the steps of:
providing a mPCM aqueous liquid slurry including an acrylics dispersion, and mPCM present in the slurry at a concentration of about 20% to 70% by weight;
combining the slurry with a cementitious binder and desiccant material in an agglomerator to form a mPCM aggregate in a continuous production process;
wherein resultant mPCM aggregate has an enthalpy or thermal energy storage capacity of 35 to 65 j/g.

2. The method of claim 1, further comprising the step of:
combining fire retardant compositions with the slurry.

3. The method of claim 2, wherein the fire retardant compositions are selected from a group consisting of magnesium hydroxide and aluminum hydroxide.

4. The method of claim 1, further comprising the step of:
sizing and grading the aggregate to a specific fineness modulus to minimize the void space between the particles to increase overall enthalpy and decrease the amount of binder in the end product.

5. The method of claim 4, wherein, the sizing produces particles having a non respirable range of sizes greater than 20 microns.

6. The method of claim 1 wherein the cementitious binder is selected from a group consisting of Portland cement, plaster of Paris, silicate cement, magnesium phosphate cement, magnesium oxychloride cement, and magnesium oxysulfate cement.

7. The method of claim 6, wherein the cementitious binder is magnesium phosphate cement.

8. A render/plaster coating made using the aggregate prepared using the method of claim 1.

9. A fire resistant wallboard made using the aggregate prepared using the method of claim 1.

10. A concrete product made using the aggregate prepared using the method of claim 1.

11. A heat exchange media for air or liquid heat exchange systems using the aggregate prepared using the method of claim 1.
